(19) United States
(12) Patent Application Publication
(10) Pub. No.: US 2018/0345893 A1
(43) Pub. Date: Dec. 6, 2018

(54) SEATBELT CONTROLLING DEVICE

(71) Applicant: TOYOTA JIDOSHA KABUSHIKI KAISHA, Toyota-shi (JP)

(72) Inventor: Shigekazu IMANAKA, Toyota-shi (JP)

(73) Assignee: TOYOTA JIDOSHA KABUSHIKI KAISHA, Toyota-shi (JP)

(21) Appl. No.: 15/962,161

(22) Filed: Apr. 25, 2018

(30) Foreign Application Priority Data
Jun. 6, 2017 (JP) 2017-111888

(51) Int. Cl. B60R 21/015; B60R 22/02; B60R 22/18

(52) U.S. Cl. CPC B60R 21/01516; B60R 22/023; B60R 2022/1806; B60R 2022/021; B60R 22/18

(57) ABSTRACT

There is provided a seatbelt controlling device including: a seatbelt that has an engaging portion, and that restrains a vehicle occupant seated in a vehicle seat; a sensing portion that is provided at the vehicle seat, and that senses seating of a vehicle occupant; a buckle that is capable of being raised and lowered or capable of being moved forward and rearward, and that is engaged with the engaging portion; a buckle moving portion that raises and lowers an engaged position of the engaging portion and the buckle, or moves the engaged position forward and rearward; and a control section that effects control to operate the buckle moving portion such that the buckle is raised or is moved forward after a set time elapses from a point in time when seating of a vehicle occupant is sensed at the sensing portion.

### CROSS-REFERENCE TO RELATED APPLICATION

This application is based on and claims priority under 35 USC 119 from Japanese Patent Application No. 2017-111888 filed on Jun. 6, 2017, the disclosure of which is incorporated by reference herein.

### BACKGROUND

### Technical Field

The present disclosure relates to a seatbelt controlling device.

### Related Art

Japanese Patent Application Laid-Open (JP-A) No. 2015-44460 discloses a buckle device in which the seating of a vehicle occupant is sensed, and a buckle is moved upward, and, after the vehicle occupant has finished putting-on the seatbelt, the buckle is lowered.

In a structure in which a buckle is raised in accordance with the timing of sensing the seating of a vehicle occupant in a vehicle seat, in a case in which the vehicle occupant who has sat-down in the vehicle seat temporarily moves their body toward the seat immediately adjacent thereto, or the like, there is the possibility that the vehicle occupant will contact the buckle that has been raised-up.

In this way, in a structure in which a buckle is moved, there is room for improvement in suppressing the buckle's limiting of movement of a vehicle occupant after the vehicle occupant has sat-down in a vehicle seat.

### SUMMARY

In view of the above-described circumstances, the present disclosure provides a seatbelt controlling device that can suppress limiting, by a buckle, of movement of a vehicle occupant after the vehicle occupant has sat-down in a vehicle seat.

A seatbelt controlling device of a first aspect of the present disclosure includes: a seatbelt that has an engaging portion, and that restrains a vehicle occupant seated in a vehicle seat; a sensing portion that is provided at the vehicle seat, and that senses seating of a vehicle occupant; a buckle that is capable of being raised and lowered or capable of being moved forward and rearward, and that is engaged with the engaging portion; a buckle moving portion that raises and lowers an engaged position of the engaging portion and the buckle, or moves the engaged position forward and rearward; and a control section that effects control to operate the buckle moving portion such that the buckle is raised or is moved forward after a set time elapses from a point in time when seating of a vehicle occupant is sensed at the sensing portion.

In the first aspect of the present disclosure, after a set time elapses from the point in time when seating of the vehicle occupant is sensed at the sensing portion, the control section operates the buckle moving portion such that the buckle rises or moves forward. In other words, the buckle does not rise or more forward until the set time has elapsed from the point in time when seating of the vehicle occupant is sensed at the sensing portion. Therefore, even if the vehicle occupant who is seated in the vehicle seat temporarily moves their body toward the seat immediately adjacent thereto, it is difficult for the buckle and the vehicle occupant to contact one another. Due thereto, in a structure in which a buckle moves, limiting, by the buckle, of the movement of the vehicle occupant after the vehicle occupant has sat-down in the vehicle seat can be suppressed.

In a seatbelt controlling device of a second aspect of the present disclosure, a pull-out detecting portion, which detects that the seatbelt has been pulled-out by a set amount or more, is provided, and the control section makes the set time be a time from a point in time, at which seating of a vehicle occupant is sensed at the sensing portion, to a point in time at which it is detected at the pull-out detecting portion that the seatbelt has been pulled-out by the set amount or more.

In the second aspect of the present disclosure, the control section carries out control so as to cause the buckle to be raised, from the point in time when it is detected at the pull-out detecting portion that the seatbelt has been pulled-out by the set amount or more. In other words, the control section does not cause the buckle to be raised until it is detected, at the pull-out sensing portion, that the seatbelt has been pulled-out by the set amount or more. Due thereto, in a case in which, after the set time has elapsed, the vehicle occupant moves the seat without carrying out the operation of putting-on the seatbelt, the buckle is not in a raised state, and therefore, the vehicle occupant contacting the buckle can be suppressed.

In a seatbelt controlling device of a third aspect of the present disclosure, an ignition switch, which is switched between an operation position at which the vehicle is operated and a stopped position at which the vehicle is stopped, is provided, and the control section effects control to operate the buckle moving portion such that the buckle is raised or is moved forward in a case in which the ignition switch is switched from the operation position to the stopped position.

In the third aspect of the present disclosure, the control section raises the buckle or moves the buckle forward in a case in which the position of the ignition switch switches from the operation position to the stopped position in a state in which the engaging portion and the buckle are engaged. Namely, when running of the vehicle is stopped, the control section raises the buckle or moves the buckle forward. Due thereto, the vehicle occupant releases the engagement of the engaging portion and the buckle in a state in which the buckle has been raised or moved forward. Thus, the engagement of the engaging portion and the buckle after running is stopped can be released easily.

In a seatbelt controlling device of a fourth aspect of the present disclosure, the vehicle seat is provided at a driver's seat of the vehicle.

In the fourth aspect of the present disclosure, at the driver's seat from which the ignition switch is operated, the buckle rises or moves forward when running is stopped. Due thereto, when the ignition switch is switched to the stopped position, it is easy for the vehicle occupant in the driver's seat to recognize that the buckle has risen or moved forward. Thus, contact between the vehicle occupant and the buckle that is in the midst of rising or is in the midst of moving forward can be suppressed.

The present disclosure has the effect of, in a structure in which a buckle moves, being able to suppress limiting, by the buckle, of movement of the vehicle occupant after the vehicle occupant has sat-down in a vehicle seat.

### BRIEF DESCRIPTION OF THE DRAWINGS

Exemplary embodiments of the present disclosure will be described in detail based on the following figures, wherein:

FIG. 1 is a structural drawing of a vehicle to which a seatbelt controlling device relating to a first embodiment is applied;

FIG. 2 is a block drawing showing a control section relating to the first embodiment, and structures that are connected to the control section;

FIG. 3 is an explanatory drawing showing a buckle relating to the first embodiment and a buckle moving portion when the buckle is at a lowered position;

FIG. 4 is an explanatory drawing showing the buckle relating to the first embodiment and the buckle moving portion when the buckle is at a raised position;

FIG. 5A is an explanatory drawing showing a non-engaged state of the buckle relating to the first embodiment and a tongue plate;

FIG. 5B is an explanatory drawing showing an engaged state of the buckle relating to the first embodiment and the tongue plate;

FIG. 6 is a timing chart showing states of operation of a seating sensor, a buckle switch and a motor, and buckle positions, relating to the first embodiment;

FIG. 7 is a flowchart showing the flow of moving processings of the buckle in the seatbelt controlling device relating to the first embodiment;

FIG. 8 is an explanatory drawing showing a state in which the tongue plate is being engaged with the buckle relating to the first embodiment;

FIG. 9 is a timing chart showing states of operation of the seating sensor, a pulled-out amount sensor, the buckle switch and the motor, and buckle positions, relating to a second embodiment;

FIG. 10 is a flowchart showing the flow of moving processings of the buckle in a seatbelt controlling device relating to the second embodiment;

FIG. 11 is a timing chart showing states of operation of an ignition switch, the buckle switch and the motor, and buckle positions, relating to a third embodiment;

FIG. 12 is a flowchart showing the flow of moving processings of the buckle in a seatbelt controlling device relating to the third embodiment; and

FIG. 13 is an explanatory drawing showing a state in which engagement of the buckle relating to the third embodiment and the tongue plate is being released.

### DETAILED DESCRIPTION

### First Embodiment

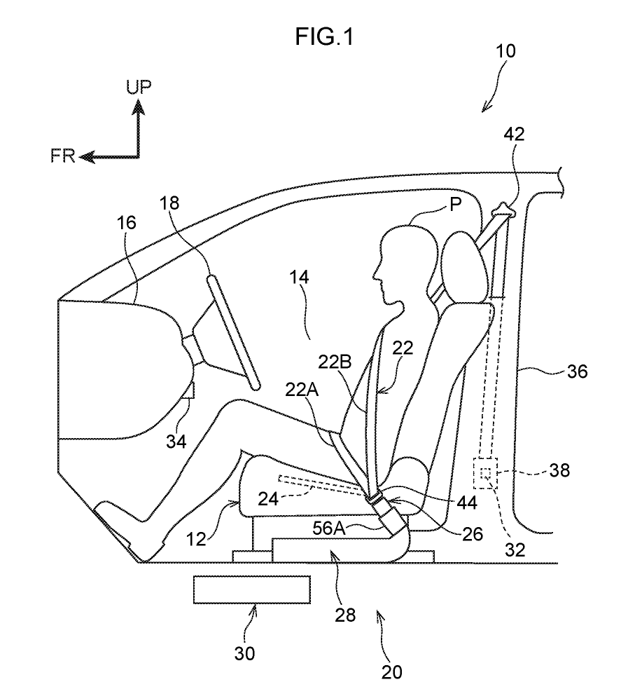

A portion of a vehicle 10 relating to a first embodiment is shown in FIG. 1. Note that arrow FR that is shown appropriately in the respective drawings indicates the vehicle forward direction (the advancing direction), arrow UP indicates the vehicle upward direction, and arrow OUT indicates a vehicle transverse direction outer side. Hereinafter, when explanation is given by merely using longitudinal, vertical and left-right directions, they refer to the longitudinal of the vehicle longitudinal direction, the vertical of the vehicle vertical direction and the left and right in the vehicle transverse direction when facing in the advancing direction, unless otherwise specified.

The vehicle 10 has a vehicle seat 12 in which a vehicle occupant P sits. As an example, the vehicle seat 12 is provided at a driver's seat 14. An instrument panel 16, a steering wheel 18, an ignition switch 34 that is described later, and the like are provided in front of the driver's seat 14. Further, a seatbelt controlling device 20 is applied to the vehicle 10.

[Structure of Main Portions]

The seatbelt controlling device 20 is described next.

As an example, the seatbelt controlling device 20 has a seatbelt 22, a seating sensor 24 that serves as an example of a sensing portion, a buckle 26, a buckle moving portion 28, a control section 30, a pulled-out amount sensor 32 that serves as an example of a pull-out sensing portion, and the ignition switch 34.

<Seatbelt>

One end portion in the length direction of the seatbelt 22 is anchored on an unillustrated spool of a retractor 38 that is fixed to the lower end portion of a B-pillar 36 of the vehicle 10. The intermediate portion in the length direction of the seatbelt 22 is trained around a shoulder anchor 42 that is mounted to the upper portion of the B-pillar 36. The other end portion in the length direction of the seatbelt 22 is anchored to an unillustrated anchor member that is fixed to the floor or a seat of the vehicle 10 in a vicinity of the lower end portion of the B-pillar 36.

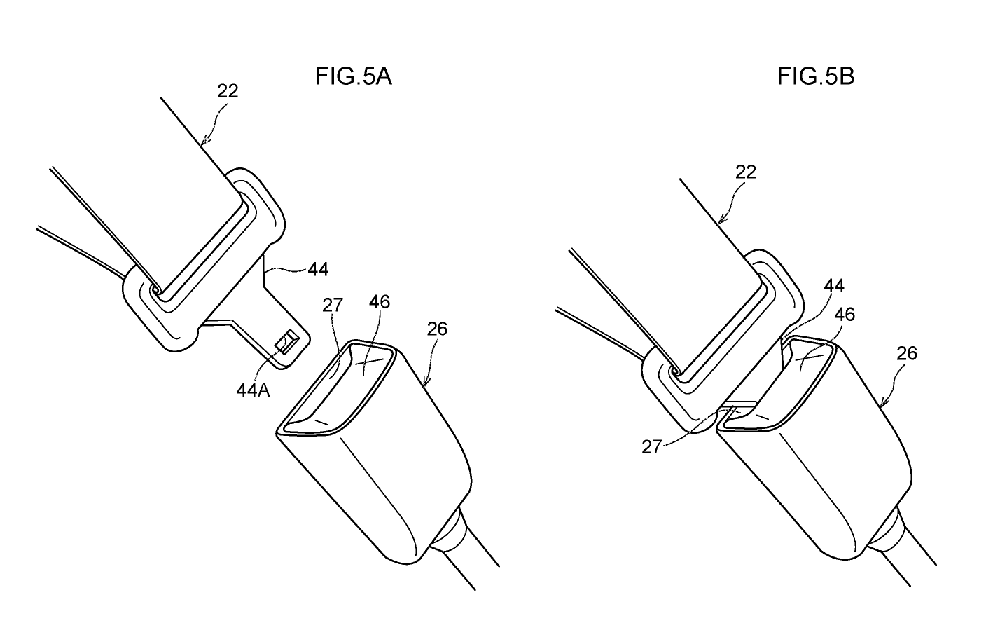

The seatbelt 22 has a tongue plate 44 that serves as an example of an engaging portion. The tongue plate 44 is provided so as to be able to slide with respect to the seatbelt 22, at the intermediate portion in the length direction of the seatbelt 22 and between the shoulder anchor 42 and the unillustrated anchor member. Further, an engagement hole 44A (see FIG. 5A) is formed in the tongue plate 44. The tongue plate 44 is engaged with the buckle 26 that is provided at a vehicle transverse direction one side of the vehicle seat 12 (the central side of the vehicle 10). Due thereto, in the state in which the tongue plate 44 is engaged with the buckle 26, the vehicle occupant P who is seated in the vehicle seat 12 is restrained at the vehicle seat 12 by the seatbelt 22.

Note that the seatbelt 22 is sectioned into a lap belt portion 22A and a shoulder belt portion 22B. The lap belt portion 22A means, of the seatbelt 22, the portion that is from the tongue plate 44 and that passes in front of the waist portion of the vehicle occupant P. The shoulder belt portion 22B means, of the seatbelt 22, the portion that is from the tongue plate 44 and that passes in front of the upper body of the vehicle occupant P and extends, via the shoulder anchor 42, to the retractor 38.

<Seating Sensor>

The seating sensor 24 is provided at the vehicle seat 12, and, as an example, senses whether or not the vehicle occupant P is seated on the basis of the applied load. Further, the seating sensor 24 is electrically connected to the control section 30 that is described later. The seating sensor 24 is structured so as to output an ON signal to the control section 30 when the vehicle occupant P is seated, and so as to output an OFF signal to the control section 30 when the vehicle occupant P is not seated.

<Buckle>

The buckle 26 shown in FIG. 5A and FIG. 5B is formed in the shape of a box that is flat and hollow, and is disposed at the vehicle transverse direction inner side of the vehicle seat 12 (see FIG. 1) (is disposed at a position in a vicinity of the waist of the vehicle occupant P). An insertion hole 27 into which the tongue plate 44 is inserted is formed in the buckle 26. Further, the buckle 26 has a structure that engages with the edge portion of the engagement hole 44A of the tongue plate 44 that is inserted in the insertion hole 27. A release button 46 that releases engagement with the tongue plate 44 is provided at the buckle 26. In this way, the tongue plate 44 is inserted into the insertion hole 27 and is engaged at the time of putting-on the seatbelt 22. When the seatbelt 22 is to be removed, the engagement of the buckle 26 and the tongue plate 44 is released due to the release button 46 being operated.

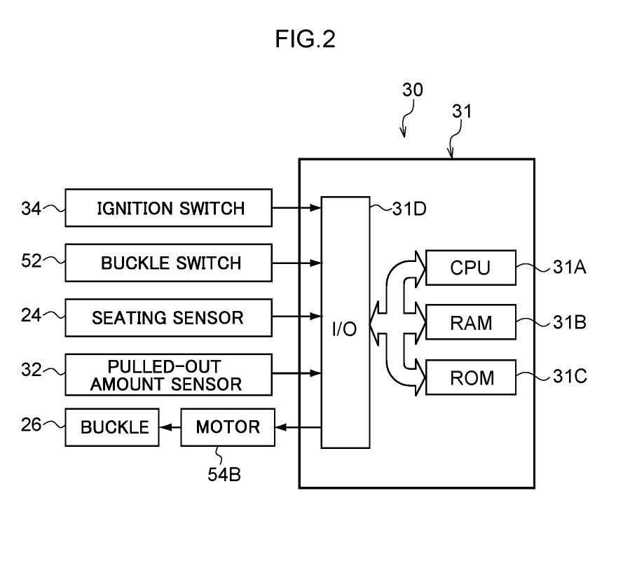

A buckle switch 52 (see FIG. 2) is provided at the interior of the buckle 26. The buckle switch 52 is set in an ON state due to the engaging of the tongue plate 44 and the engaging structure at the interior of the buckle 26, and is set in an OFF state when the engagement is released. Further, the buckle switch 52 is electrically connected to the control section 30 (see FIG. 1) that is described later. The buckle switch 52 is structured so as to, when in the ON state, output an ON signal to the control section 30, and, when in the OFF state, output an OFF signal to the control section 30.

<Buckle Moving Portion>

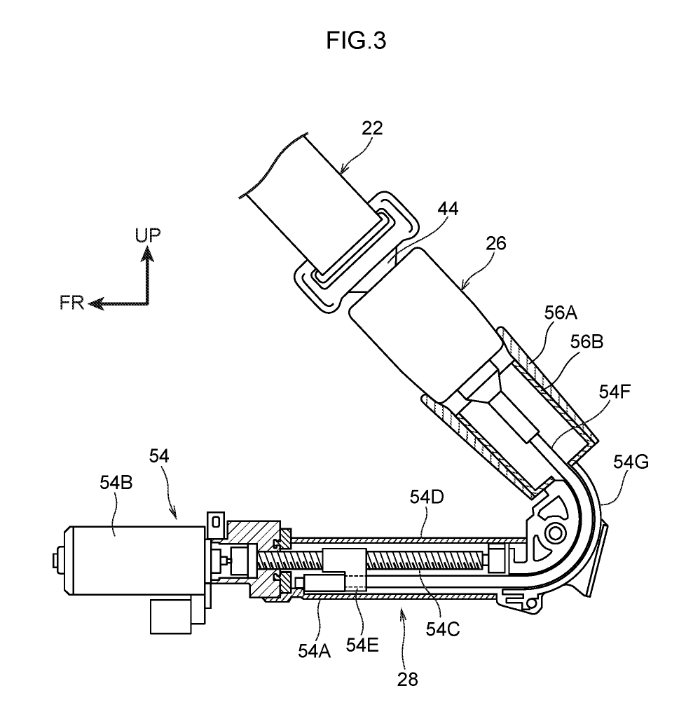

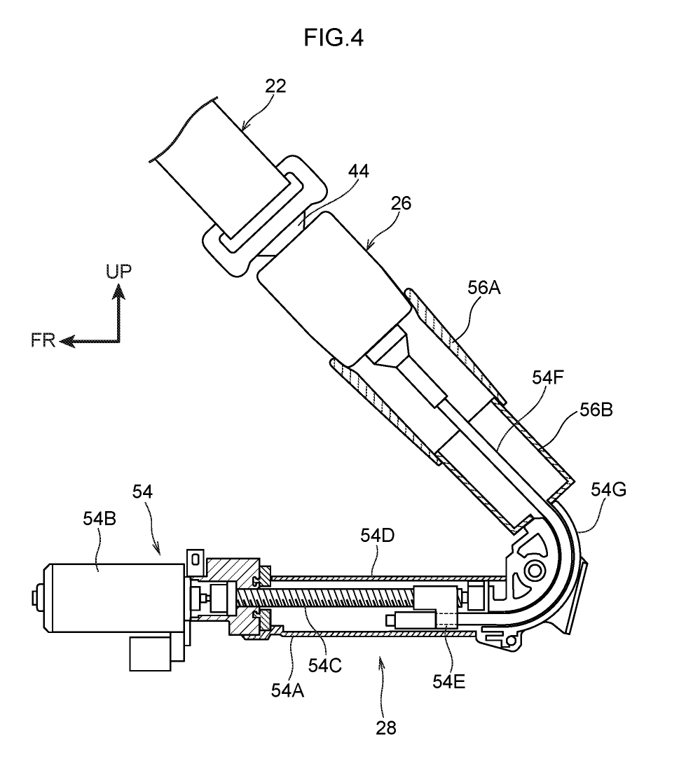

The buckle moving portion 28 shown in FIG. 3 has, as an example, a driving portion 54 that drives the buckle 26, and guiding portions 56A, 56B that are mounted to the driving section 54 and guide the buckle 26 in one direction. Note that, in FIG. 3 and FIG. 4, the buckle moving portion 28 is shown in a state in which a cover member is removed therefrom.

(Driving Portion)

As an example, the driving portion 54 is structured to include a case 54A, a motor 54B, a rotating shaft 54C, a guide shaft 54D, a movable member 54E, and a connecting member 54F. The case 54A is formed in the shape of a box that extends in the vehicle longitudinal direction. A curved portion 54G that is curved toward the vehicle front side is formed at the rear end portion in the vehicle longitudinal direction of the case 54A. At the curved portion 54G movement of the connecting member 54F, which is described later, in directions other than a one direction (a guiding direction) is restricted such that the moving direction of the connecting member 54F becomes the one direction.

The motor 54B is electrically connected to the control section 30 (see FIG. 1) that is described later, and the rotation and stopping of the motor 54B are controlled by the control section 30. The rotating shaft 54C extends from the motor 54B toward the rear side in the vehicle longitudinal direction such that the central axis thereof runs along the vehicle longitudinal direction. A female screw is formed at the outer peripheral surface of the rotating shaft 54C. The guide shaft 54D is disposed substantially parallel to the rotating shaft 54C, and extends from the motor 54B side to the curved portion 54G side.

An unillustrated through-hole that passes-through in the vehicle longitudinal direction is formed in the movable member 54E. A male screw, which engages with the female screw of the rotating shaft 54C, is formed at the inner wall of this through-hole. The connecting member 54F is structured by a metal wire as an example. One end portion in the axial direction of the connecting member 54F is fixed to the movable member 54E. The other end portion in the axial direction of the connecting member 54F is fixed to the lower end portion of the buckle 26.

(Guiding Portions)

As an example, the guiding portions 56A, 56B are structured in the shapes of quadrangular tubes. The size of the guiding portion 56A is made to be a size that is such that the guiding portion 56B can be accommodated at the interior thereof. Further, the guiding portion 56A is mounted to the buckle 26, and the guiding portion 56B is mounted to the driving portion 54 by using mounting means such as screws or the like as an example. Moreover, the guiding portion 56B is disposed at an incline such that the upper end portion thereof in the vehicle vertical direction is positioned at the vehicle longitudinal direction front side with respect to the lower end portion thereof. Due thereto, when the connecting member 54F moves, the buckle 26 is guided along the direction of inclination of the guiding portion 56B.

Here, as shown in FIG. 4, due to the motor 54B being rotated forward, the female screw of the rotating shaft 54C rotates forward, the movable member 54E moves rectilinearly toward the rear side in the vehicle longitudinal direction, and the connecting member 54F causes the buckle 26 to rise (extend). On the other hand, as shown in FIG. 3, due to the motor 54B being rotated reversely, the female screw of the rotating shaft 54C is rotated reversely, the movable member 54E moves rectilinearly toward the front side in the vehicle longitudinal direction, and the connecting member 54F causes the buckle 26 to be lowered (stored). In this way, the buckle moving portion 28 raises and lowers (extends and stores) the engaged position that is the central position of the portion where the tongue plate 44 and the buckle 26 are engaged.

<Control Section>

The control section 30 shown in FIG. 2 is structured to include an ECU (Electronic Control Unit) 31. The ECU 31 is structured by a microcomputer that has a CPU 31A, a RAM 31B, a ROM 31C, and an input/output interface (I/O) 31D. A program for raising (extending) or lowering (storing) the buckle 26, a set time from the point in them when seating of the vehicle occupant P is sensed at the seating sensor 24, and the like are stored in the ROM 31C. On the basis of the program stored in the ROM 31C, the raising or lowering of the buckle 26 is controlled at the ECU 31. Note that the ignition switch 34, the buckle switch 52, the seating sensor 24, and the pulled-out amount sensor 32 are connected to the I/O 31D. Further, an unillustrated timer for measuring time is provided at the control section 30.

The control section 30 carries out control that operates the motor 54B so that the buckle 26 is raised after a set time has elapsed from the point in time when seating of the vehicle occupant P is sensed at the seating sensor 24.

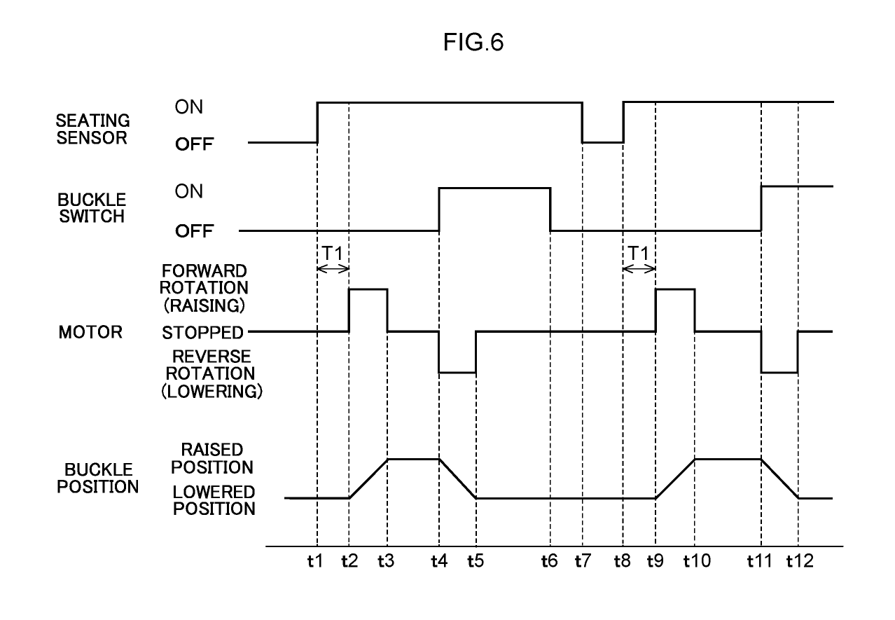

FIG. 6 shows, as an example of control by the control section 30 of the first embodiment, a timing chart for the turning ON/OFF of the seating sensor 24, the turning ON/OFF of the buckle switch 52, the forward rotation, the stopping and the reverse rotation of the motor 54B, and the raised position/lowered position of the buckle 26. Note that, the greater the number of the point in time t, the longer the time that has elapsed from point in time t1.

At point in time t1, the seating sensor 24 turns ON. At point in time t2 at which time T1 has elapsed from point in time t1, forward rotation of the motor 54B is started, and raising of the buckle 26 is started. At point in time t3, the buckle 26 has risen to a predetermined height, and therefore, the forward rotation of the motor 54B is stopped. When the buckle switch 54 turns ON at point in time t4, reverse rotation of the motor 54B is started, and lowering of the buckle 26 is started. At point in time t5, the buckle 26 has fallen to its original height (reference height), and therefore, the reverse rotation of the motor 54B is stopped.

At point in time t6, the buckle switch 52 turns OFF. This means, for example, a case in which the vehicle occupant P has released the engagement of the tongue plate 44 and the buckle 26 during automatic driving of the vehicle 10. At point in time t7, the seating sensor 24 turns OFF. This means a state in which the vehicle occupant P has gotten-up during automatic driving.

At point in time t8, the seating sensor 24 turns ON. At point in time t9 at which time T1 has elapsed from point in time t8, forward rotation of the motor 54B is started, and raising of the buckle 26 is started. At point in time t10, the buckle 26 has risen to a predetermined height, and therefore, the forward rotation of the motor 54B is stopped. When the buckle switch 52 turns ON at point in time t11, reverse rotation of the motor 54B is started, and lowering of the buckle 26 is started. At point in time t12, because the buckle 26 has fallen to its original height (reference height), the reverse rotation of the motor 54B is stopped. Thereafter, although not illustrated, in a state in which the vehicle 10 is stopped, the buckle switch 52 is turned OFF, and the seating sensor 24 turns OFF due to the vehicle occupant P moving away from the vehicle seat 12.

(Regarding the Set Time)

The aforementioned time T1 is a time that is set in advance at the control section 30 so as to be a time that is greater than or equal to a set time that is a reference. The “set time” means a time that is set in advance as the time from the point in time, at which the vehicle occupant P sits-down in the vehicle seat 12, to the point in time at which at least the vehicle occupant P grasps the tongue plate 44 or the seatbelt 22. Therefore, the “point in time at which the set time has elapsed” does not include the point in time when the vehicle occupant P sits-down in the seat P and points in time when the vehicle occupant P is not grasping the tongue plate 44 or the seatbelt 22.

<Pulled-Out Amount Sensor>

At the pulled-out amount sensor 32 that is shown in FIG. 1, the pulled-out amount of the seatbelt 22 at points in time before the vehicle occupant P is sensed by the seating sensor 24 is made to be zero. Then, at a point in time that is after the sensing of the vehicle occupant P by the seating sensor 24, the pulled-out amount of the seatbelt 22 is detected by detecting the amount of rotation of an unillustrated spool of the retractor 38. In this way, the pulled-out amount sensor 32 detects that the seatbelt 22 has been pulled-out by a set amount or more. Note that, in the first embodiment, control that is based on the pulled-out amount that is detected at the pulled-out amount sensor 32 is not carried out.

<Ignition Switch>

The ignition switch 34 is structured so as to start or stop an unillustrated engine of the vehicle 10. Concretely, the engine is started due to an unillustrated key being inserted into the ignition switch 34, and the key being rotated a predetermined angle. Further, the engine is stopped due to the key being rotated in the direction opposite to that at the time of starting the engine. The position of the ignition switch 34 at the time when the engine is started (the vehicle 10 is made to operate) is called the operation position. Further, the position of the ignition switch 34 when the engine is stopped (the vehicle 10 is stopped) is called the stopped position. The ignition switch 34 is ON at the operation position, and is OFF at the stopped position. Namely, the ignition switch 34 is switched between the operation position and the stopped position.

[Operation and Effects]

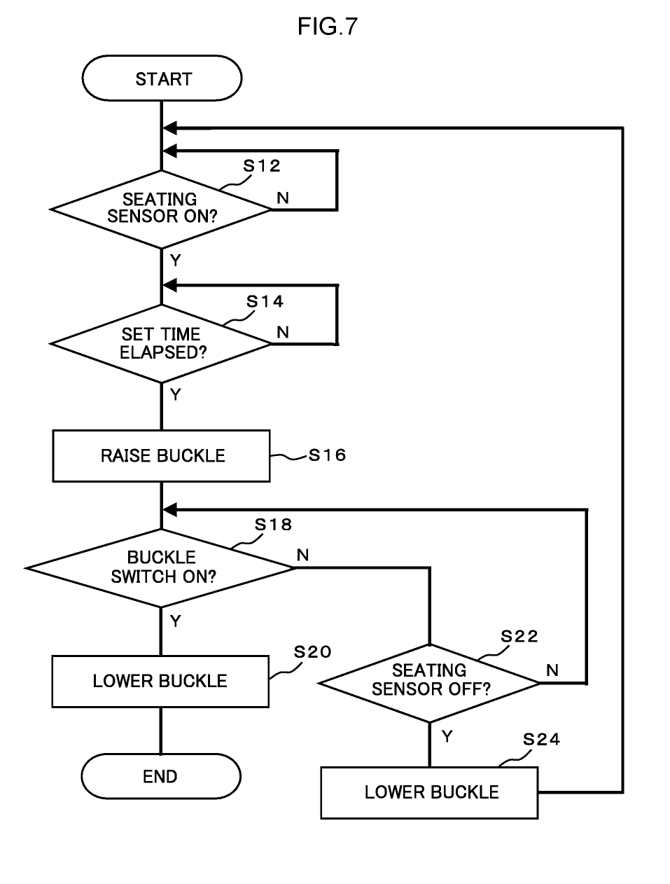

Operation and effects of the seatbelt controlling device 20 of the first embodiment are described next by using the flowchart of FIG. 7. Note that reference is made to FIG. 1 through FIG. 5B for the respective portions and respective members of the vehicle 10.

In step S12 of the flowchart of FIG. 7, the control section 30 judges whether or not the seating sensor 24 is ON. If the seating sensor 24 is OFF, this judgment is repeated until the seating sensor 24 turns ON. If the seating sensor 24 is ON, the routine moves on to step S14.

In step S14, the control section 30 judges whether or not the time that has elapsed from the turning ON of the seating sensor 24 is greater than or equal to the set time. If the elapsed time is shorter than the set time, this judgment is repeated until the elapsed time becomes greater than or equal to the set time. When the elapsed time becomes greater than or equal to the set time, the routine moves on to step S16.

In step S16, the control section 30 rotates the motor 54B forward, and causes the buckle 26 to be raised. Note that, at the point in time when the amount of rotation of the motor 54B becomes a set amount of rotation (the point in time when the buckle 26 is raised to a set height), the control section 30 stops the rotation of the motor 54B. Then, the routine moves on to step S18.

In step S18, the control section 30 judges whether or not the buckle switch 52 is ON. If the buckle switch 52 is ON, the routine moves on to step S20. If the buckle switch 52 is OFF, the routine moves on to step S22.

In step S20, the control section 30 rotates the motor 54B reversely and causes the buckle 26 to be lowered. Note that, at the point in time when the amount of rotation of the motor 54B becomes a set amount of rotation (the point in time when the buckle 26 is lowered to a set height), the control section 30 stops the rotation of the motor 54B. Then, the program ends.

In step S22, the control section 30 judges whether or not the seating sensor 24 is OFF. If the seating sensor 24 is OFF, the routine moves on to step S24. In step S24, the control section 30 rotates the motor 54B reversely and causes the buckle 26 to be lowered, and the routine moves on to step S12. If the seating sensor 24 is ON, the routine moves on to step S18.

As described above, at the seatbelt controlling device 20 of the first embodiment, after a set time has elapsed from the point in time when the seating of the vehicle occupant P is sensed by the seating sensor 24, the control section 30 operates the buckle moving portion 28 such that the buckle 26 rises. In other words, the buckle 26 does not rise until the set time elapses from the point in time when the seating of the vehicle occupant P is sensed at the seating sensor 24. Therefore, even if the vehicle occupant P who is seated in the vehicle seat 12 temporarily moves their body toward the seat immediately adjacent thereto, it is difficult for the buckle 26 and the vehicle occupant P to contact one another. Due thereto, in a structure in which the buckle 26 moves, the buckle 26 limiting movement of the vehicle occupant P after the vehicle occupant P has sat-down in the vehicle seat 12 can be suppressed.

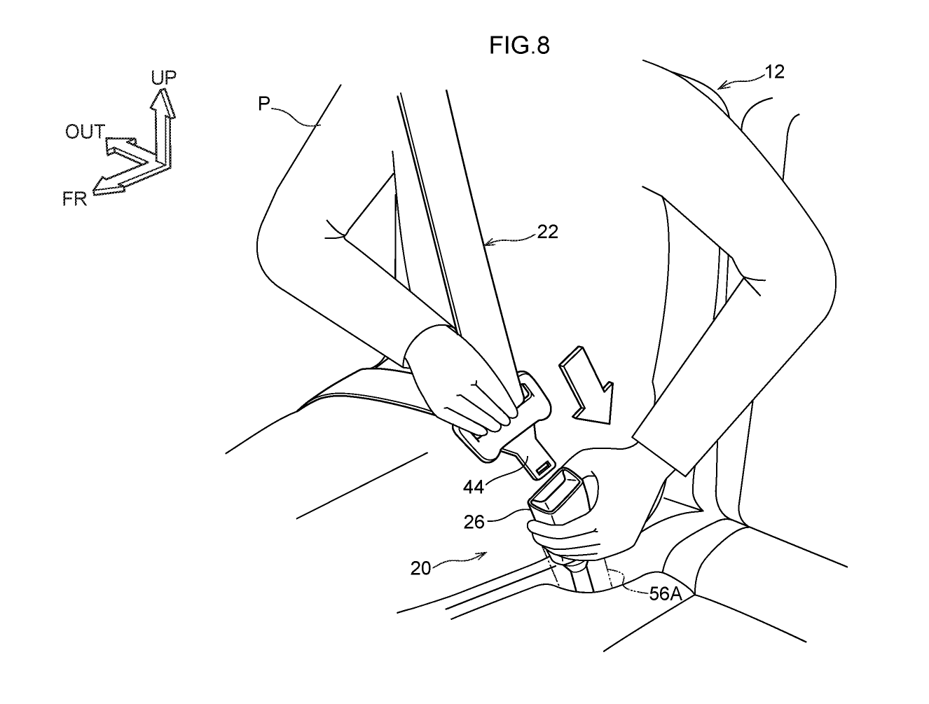

Further, as shown in FIG. 8, in the seatbelt controlling device 20 of the first embodiment, when the tongue plate 44 is to be engaged with the buckle 26, the buckle 26 is raised with respect to the lowered position (the reference position). Therefore, the vehicle occupant P does not have to confirm the position of the buckle 26 by tilting their upper body or the like (the vehicle occupant P does not have to search for the buckle 26). Thus, the tongue plate 44 and the buckle 26 can be engaged easily.

### Second Embodiment

The seatbelt controlling device 20 relating to the second embodiment is described next. Note that members and regions that are basically the same as those of the above-described first embodiment are denoted by the same reference numerals as in the first embodiment, and description thereof is omitted. Further, reference is made to FIG. 1 through FIG. 5B for the respective members and respective portions of the vehicle 10 whose structures are similar to those of the first embodiment.

In the seatbelt controlling device 20 of the second embodiment, at the control section 30, the set amount of the pulled-out amount of the seatbelt 22 is set to 100 mm as an example. Further, at the control section 30, the time that is from the point in time, at which seating of the vehicle occupant P is sensed by the seating sensor 24, until the point in time at which the pulled-out amount sensor 32 detects that the seatbelt 22 has been pulled-out by the set amount (100 mm) or more, is set as the set time. In other words, in the seatbelt controlling device 20 of the second embodiment, the buckle 26 rises (extends) from the point in time when the pulled-out amount sensor 32 detects that the seatbelt 22 has been pulled-out by the set amount or more (the point in time when the pulled-out amount sensor 32 turns ON).

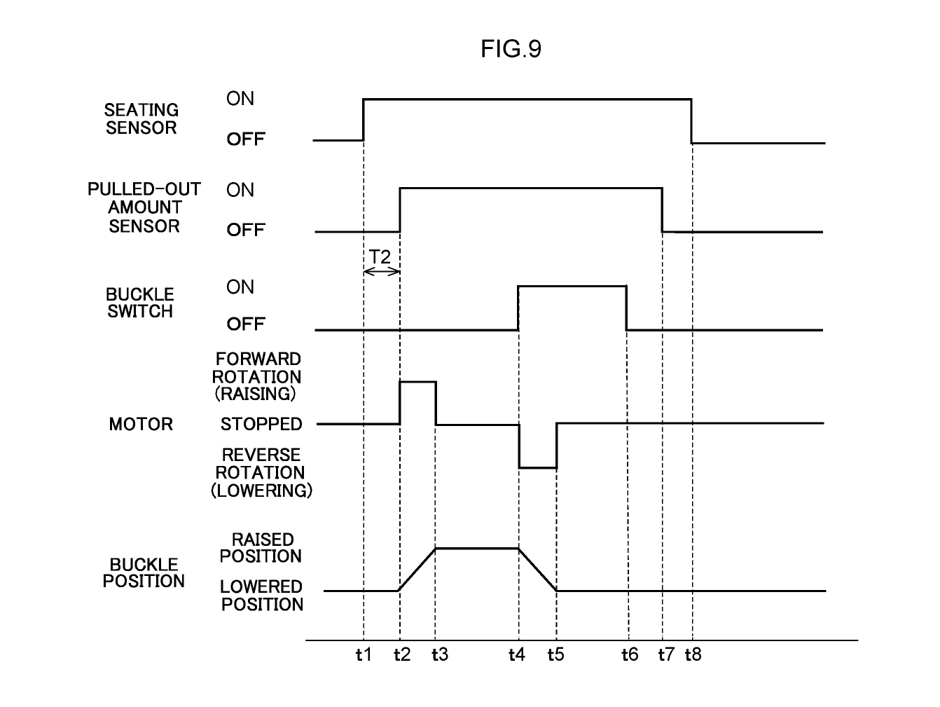

FIG. 9 shows a timing chart as an example of control by the control section 30 of the second embodiment. The turning ON/OFF of the seating sensor 24, the turning ON/OFF of the pulled-out amount sensor 32, the turning ON/OFF of the buckle switch 52, the forward rotation, the stopping and the reverse rotation of the motor 54B, and the raised position/lowered position of the buckle 26 are illustrated in this timing chart. Note that, the greater the number of the point in time t, the longer the time that has elapsed from point in time t1. Further, these respective points in time are described as starting from point in time t1, but differ from the respective points in time of the first embodiment.

At point in time t1, the seating sensor 24 turns ON. At point in time t2 at which time T2 has elapsed from point in time t1, the aforementioned set amount is detected at the pulled-out amount sensor 32, and the pulled-out amount sensor 32 turns ON, and forward rotation of the motor 54B is started, and raising (extending) of the buckle 26 is started. At point in time t3, the buckle 26 has risen to a predetermined height, and therefore, the forward rotation of the motor 54B is stopped. When the buckle switch 54 turns ON at point in time t4, reverse rotation of the motor 54B is started, and lowering (storing) of the buckle 26 is started. At point in time t5, the buckle 26 has fallen to its original height (reference height), and therefore, the reverse rotation of the motor 54B is stopped.

At point in time t6, the buckle switch 52 turns OFF. This means, for example, a case in which the vehicle occupant P has released the engagement of the tongue plate 44 and the buckle 26 during automatic driving of the vehicle 10. At point in time t7, it is detected that the pulled-out amount of the seatbelt 22 has become shorter than the set amount. Namely, the pulled-out amount sensor 32 turns OFF. At point in time t8, the seating sensor 24 turns OFF. This means a state in which the vehicle occupant P has gotten-up during automatic driving. Thereafter, in the control from the time when the vehicle occupant P sits-down in the vehicle seat 12, the control pattern from point in time t1 to point in time t8 is repeated.

[Operation and Effects]

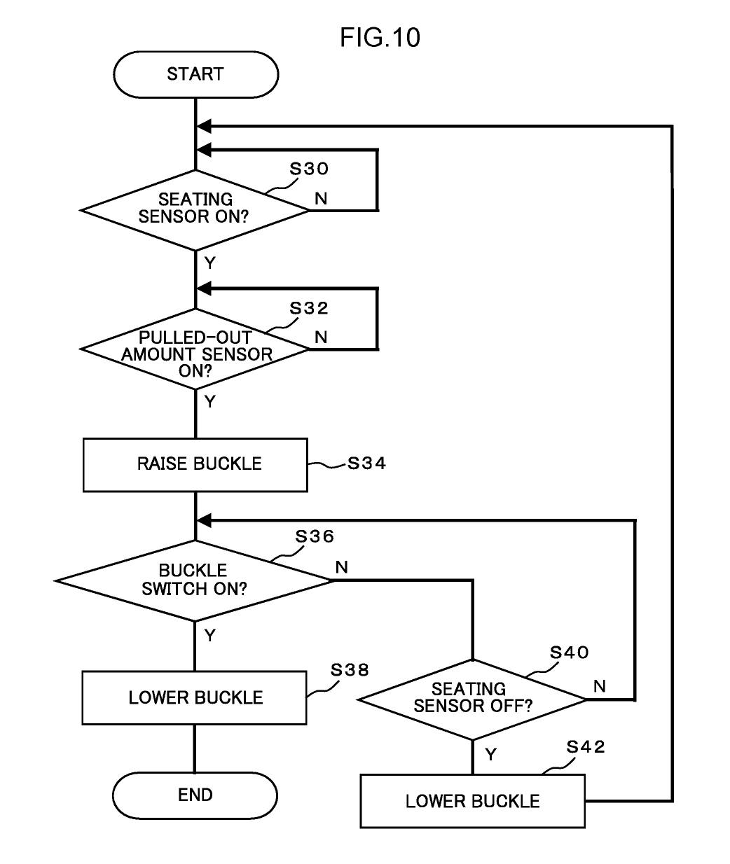

Operation and effects of the seatbelt controlling device 20 of the second embodiment are described next by using the flowchart of FIG. 10. Note that reference is made to FIG. 1 through FIG. 5B for the respective portions and respective members of the vehicle 10.

In step S30 of the flowchart of FIG. 10, the control section 30 judges whether or not the seating sensor 24 is ON. If the seating sensor 24 is OFF, this judgment is repeated until the seating sensor 24 turns ON. If the seating sensor 24 is ON, the routine moves on to step S32.

In step S32, the control section 30 judges whether or not the pulled-out amount sensor 32 is ON. If the pulled-out amount sensor 32 is OFF (if the time that has elapsed from the seating sensor 24 turning ON is shorter than the set time), this judgment is repeated until the pulled-out amount sensor 32 turns ON. When the pulled-out amount sensor 32 turns ON, the routine moves on to step S34.

In step S34, the control section 30 rotates the motor 54B forward, and causes the buckle 26 to be raised. Note that, at the point in time when the amount of rotation of the motor 54B becomes a set amount of rotation, the control section 30 stops the rotation of the motor 54B. Then, the routine moves on to step S36.

In step S36, the control section 30 judges whether or not the buckle switch 52 is ON. If the buckle switch 52 is ON, the routine moves on to step S38. If the buckle switch 52 is OFF, the routine moves on to step S40.

In step S38, the control section 30 rotates the motor 54B reversely and causes the buckle 26 to be lowered. Note that, at the point in time when the amount of rotation of the motor 54B becomes a set amount of rotation, the control section 30 stops the rotation of the motor 54B. Then, the program ends.

In step S40, the control section 30 judges whether or not the seating sensor 24 is OFF. If the seating sensor 24 is OFF, the routine moves on to step S42. If the seating sensor 24 is ON, the routine moves on to step S36. In step S42, the control section 30 rotates the motor 54B reversely and causes the buckle 26 to be lowered, and the routine moves on to step S30.

As described above, at the seatbelt controlling device 20 of the second embodiment, the control section 30 carries out control to raise the buckle 26, from the point in time when the pulled-out amount sensor 32 detects that the seatbelt 22 has been pulled-out by a set amount or more. In other words, the buckle 26 is not raised until the pulled-out amount sensor 32 detects that the seatbelt 22 has been pulled-out by the set amount or more. Due thereto, the buckle 26 is not in a raised state in a case in which, after the set time has elapsed, the vehicle occupant P moves the seat without having carried out the operation of putting-on the seatbelt 22. Therefore, the vehicle occupant P contacting the buckle 26 can be suppressed.

Further, in the seatbelt controlling device 20 of the second embodiment, when the tongue plate 44 is to be engaged with the buckle 26, the buckle 26 is in a raised state with respect to the lowered position (the reference position). Thus, the vehicle occupant P does not have to confirm the position of the buckle 26 by tilting their upper body or the like (the vehicle occupant P does not have to search for the buckle 26). Thus, the tongue plate 44 and the buckle 26 can be engaged easily.

### Third Embodiment

The seatbelt controlling device 20 relating to the third embodiment is described next. Note that members and regions that are basically the same as those of the above-described first embodiment are denoted by the same reference numerals as in the first embodiment, and description thereof is omitted. Further, reference is made to FIG. 1 through FIG. 5B for the respective members and respective portions of the vehicle 10 whose structures are similar to those of the first embodiment.

In the seatbelt controlling device 20 of the third embodiment, in a case in which the ignition switch 34 is switched from the aforementioned operation position to the stopped position, the control section 30 effects control so as to operate the buckle moving portion 28 such that the buckle 26 is raised (extended). Namely, the control in the third embodiment is controlling of the buckle 26 while running of the vehicle 10 is stopped, as compared with the control in the first embodiment that is control of the buckle 26 when running of the vehicle 10 starts and while the vehicle 10 is running.

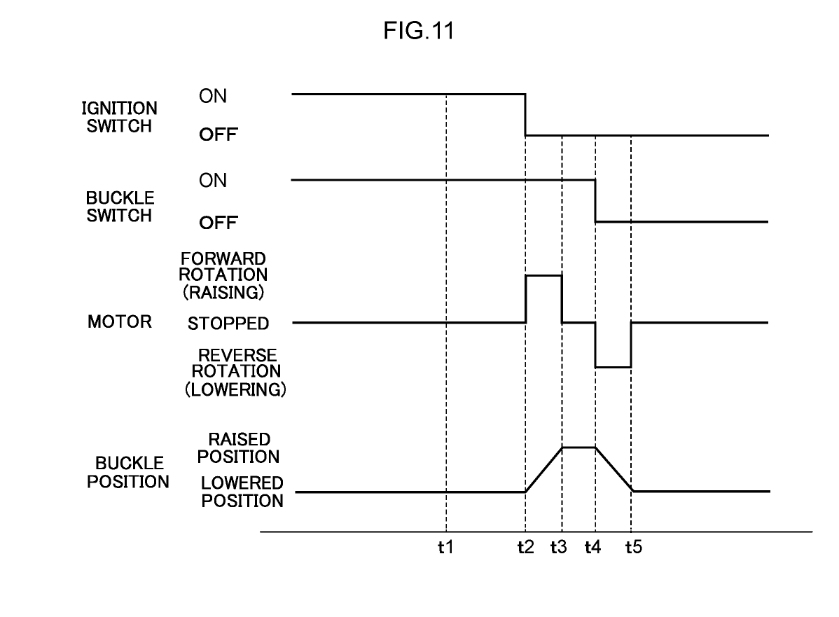

FIG. 11 shows a timing chart as an example of control by the control section 30 of the third embodiment. The turning ON/OFF of the ignition switch 34, the turning ON/OFF of the buckle switch 52, the forward rotation, the stopping and the reverse rotation of the motor 54B, and the raised position/lowered position of the buckle 26 are illustrated in this timing chart. Note that, the greater the number of the point in time t, the longer the time that has elapsed from point in time t1. Further, these respective points in time are described as starting from point in time t1, but differ from the respective points in time of the first and second embodiments.

Point in time t1 expresses a point in time during running of the vehicle 10. At point in time t1, the ignition switch 34 is ON, the buckle switch 52 is ON, the motor 54B is in a stopped state, and the buckle 26 is at the lowered position (the position that is at a reference height). At point in time t2, the ignition switch 34 turns OFF, and forward rotation of the motor 54B is started, and raising of the buckle 26 is started. At point in time t3, the buckle 26 has risen to a predetermined height, and therefore, the forward rotation of the motor 54B is stopped. When the buckle switch 52 turns OFF at point in time t4, reverse rotation of the motor 54B is started, and lowering (storing) of the buckle 26 is started. At point in time t5, the buckle 26 has been lowered to its original height (reference height), and therefore, the reverse rotation of the motor 54B is stopped.

[Operation and Effects]

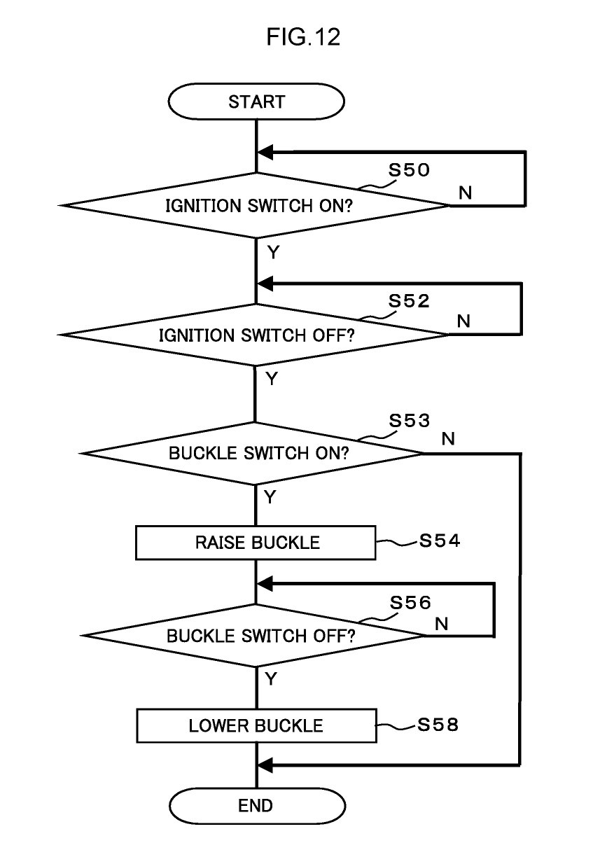

Operation and effects of the seatbelt controlling device 20 of the third embodiment are described next by using the flowchart of FIG. 12. Note that reference is made to FIG. 1 through FIG. 5B for the respective portions and respective members of the vehicle 10.

In step S50 of the flowchart of FIG. 12, the control section 30 judges whether or not the ignition switch 34 is ON. If the ignition switch 34 is OFF, this judgment is repeated until the ignition switch 34 turns ON. If the ignition switch 34 is ON, the vehicle 10 is in a running state, and the routine moves on to step S52.

In step S52, the control section 30 judges whether or not the ignition switch 34 is OFF. If the ignition switch 34 is OFF, the routine moves on to step S53. If the ignition switch 34 is ON, this judgment is repeated until the ignition switch 34 is turned OFF.

In step S53, it is judged whether or not the buckle switch 52 is ON. If the buckle switch 52 is ON, the routine moves on to step S54. If the buckle switch 52 is OFF, the program ends.

In step S54, the control section 30 rotates the motor 54B forward, and causes the buckle 26 to be raised. Note that, at the point in time when the amount of rotation of the motor 54B becomes a set amount of rotation, the control section 30 stops the rotation of the motor 54B. Then, the routine moves on to step S56.

In step S56, the control section 30 judges whether or not the buckle switch 52 is OFF. If the buckle switch 52 is OFF, the routine moves on to step S58. If the buckle switch 52 is ON, this judgment is repeated until the buckle switch 52 turns OFF.

In step S58, the control section 30 rotates the motor 54B reversely and causes the buckle 26 to be lowered. Note that, at the point in time when the amount of rotation of the motor 54B becomes a set amount of rotation, the control section 30 stops the rotation of the motor 54B. Then, the program ends.

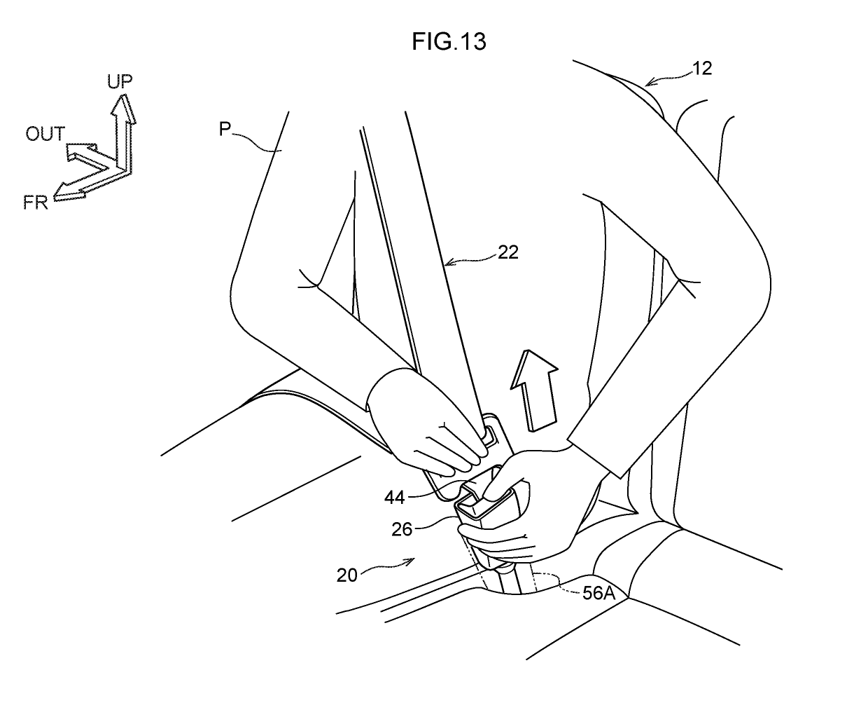

As described above, at the seatbelt controlling device 20 of the third embodiment, the control section 30 causes the buckle 26 to be raised in a case in which the position of the ignition switch 34 switches from the operation position to the stopped position in a state in which the tongue plate 44 and the buckle 26 are engaged. Namely, the control section 30 cause the buckle 26 to be raised when running of the vehicle 10 is stopped. Due thereto, as shown in FIG. 13, because the vehicle occupant P releases the engagement of the tongue plate 44 and the buckle 26 while the buckle 26 is in the raised state, the engagement of the tongue plate 44 and the buckle 26 after running is stopped can be released easily.

Further, in the seatbelt controlling device 20 of the third embodiment, the buckle 26 is raised when running is stopped, at the driver's seat 14 from which the ignition switch 34 is operated. Due thereto, it is easy for the vehicle occupant P of the driver's seat 14 to recognize that the buckle 26 is raised when the vehicle occupant P switches the ignition switch 34 to the stopped position, and therefore, contact between the vehicle occupant P and the buckle 26 that is in the midst of rising can be suppressed.

### Modified Example

Note that the present disclosure is not limited to the above-described embodiments.

In the seatbelt controlling device 20 of the first embodiment, it suffices to not provide the pulled-out amount sensor 32.

In the seatbelt controlling device 20 of the second embodiment, the buckle 26 may be raised when the ignition switch 34 is switched to the stopped position and the running of the vehicle 10 is stopped.

In the seatbelt controlling devices 20 of the first, second and third embodiments, during the time when the seating sensor 24 is ON after the buckle 26 has been raised, the buckle 26 may be maintained at the raised position without being lowered.

The seating sensor 24 is not limited to a structure that senses the absence/presence of seating of the vehicle occupant P on the basis of the applied load, and may be structured by an infrared sensor that senses infrared rays emitted from a human body.

The buckle moving portion 28 is not limited to a structure that raises and lowers the buckle 26 in an oblique direction, and may be a structure that raises and lowers the buckle 26 in the vehicle vertical direction. Further, the buckle moving portion 28 may be a structure that, when seen from the vehicle longitudinal direction, moves the buckle 26 toward the side of approaching the vehicle occupant P, and a structure that moves the buckle 26 toward the side of moving away from the vehicle occupant P. Moreover, the buckle moving portion 28 may be a structure that moves the buckle 26 in the vehicle longitudinal direction. Namely, in the seatbelt controlling devices 20 of the first, second and third embodiments, there may be a structure in which the raising of the buckle 26 is replaced by movement toward the front of the vehicle 10, and the lowering of the buckle 26 is replaced by movement toward the rear of the vehicle 10. The raising and lowering of the buckle 26 in an oblique direction includes movement of the buckle 26 forward and rearward. Note that, in the present embodiment, the buckle 26 rising or moving forward means the buckle 26 extending. Further, the buckle 26 falling or moving rearward means the buckle 26 being stored. This storage is not limited to storage at the inner side of a hollow member, and includes the buckle 26 being disposed at (returned to) the reference position while still being exposed.

The pulled-out amount sensor 32 is not limited to a structure that detects the pulled-out amount of the seatbelt 22 by detecting the amount of rotation of the unillustrated spool of the retractor 38. For example, a seal member that reflects light may be mounted to a predetermined position of the seatbelt, and it may be sensed that the pulled-out amount has become the set amount or more by sensing the passage of this sealing member at a light sensing portion that is provided with a light-emitting portion and a light-receiving portion.

The buckle 26 is not limited to a structure that moves to a lowered position that is a reference and a raised position, and may be a structure that moves to a pulled-in position that is at the lower side with respect to a lowered position that is the reference. In this structure, a collision preventing safety sensor is connected to the control section 30, and, on the basis of the information sensed by this sensor, the buckle 26 is pulled-in to the pulled-in position by the buckle moving portion 28 immediately before a collision, and, due thereto, the force of restraining the waist portion of the vehicle occupant P is increased, and the posture of the vehicle occupant P at the time of a collision is stabilized. Note that, for example, an obstacle discriminating sensor, automatic braking, sudden braking, a side slip sensor, or the like is used as the collision preventing safety sensor.

Examples of seatbelt controlling devices relating to respective embodiments and modified examples of the present disclosure have been described above. However, these respective embodiments and modified examples may be used by being combined together appropriately, and the present disclosure can, of course, be implemented in various ways within a scope that does not depart from the gist thereof.

What is claimed is:

1. A seatbelt controlling device comprising:
a seatbelt that has an engaging portion, and that restrains a vehicle occupant seated in a vehicle seat;
a sensing portion that is provided at the vehicle seat, and that senses seating of a vehicle occupant;
a buckle that is capable of being raised and lowered or capable of being moved forward and rearward, and that is engaged with the engaging portion;
a buckle moving portion that raises and lowers an engaged position of the engaging portion and the buckle, or moves the engaged position forward and rearward; and
a control section that effects control to operate the buckle moving portion such that the buckle is raised or is moved forward after a set time elapses from a point in time when seating of a vehicle occupant is sensed at the sensing portion.

2. The seatbelt controlling device of claim 1, further comprising:
a pull-out detecting portion, which detects that the seatbelt has been pulled-out by a set amount or more,
wherein the control section makes the set time be a time from a point in time at which seating of a vehicle occupant is sensed at the sensing portion, to a point in time at which it is detected at the pull-out detecting portion that the seatbelt has been pulled-out by the set amount or more.

3. The seatbelt controlling device of claim 1, further comprising:
an ignition switch, which is switched between an operation position at which the vehicle is operated and a stopped position at which the vehicle is stopped,
wherein the control section effects control to operate the buckle moving portion such that the buckle is raised or is moved forward in a case in which the ignition switch is switched from the operation position to the stopped position.

4. The seatbelt controlling device of claim 3, wherein the vehicle seat is provided at a driver's seat of the vehicle.
